(19) United States
(12) Patent Application Publication
(10) Pub. No.: US 2026/0140983 A1
(43) Pub. Date: May 21, 2026

(54) LANGUAGE GENERATION MODEL PROCESSING OPTIMIZATION USING CONTEXT EXAMPLE BATCHING

(71) Applicant: ADOBE INC., San Jose, CA (US)

(72) Inventors: Kunjal Panchal, Amherst, MA (US); Somdeb Sarkhel, San Jose, CA (US); Saayan Mitra, San Jose, CA (US); Sunav Choudhary, Kolkata (IN)

(21) Appl. No.: 18/953,461

(22) Filed: Nov. 20, 2024

(51) Int. Cl. G06F 16/33; G06F 16/332

(52) U.S. Cl. CPC G06F 16/3344; G06F 16/3329

(57) ABSTRACT

A method, non-transitory computer readable medium, system, and apparatus for data processing includes obtaining a user query and a plurality of context examples and generating a first input and a second input. The first input comprises the user query appended to a first portion of the plurality of context examples, and the second input comprises the user query appended to a second portion of the plurality of context examples. The method, non-transitory computer readable medium, system, and apparatus for data processing further includes generating a response to the user query based on the first input and the second input.

### BACKGROUND

The following relates generally to machine learning, and more specifically to language generation processing optimization. Language generation models, such as large language models, are machine learning models that are trained to predict a text output in response to an input prompt. An accuracy of the prediction is increased if the prompt relates to data that is used to train the language generation model. Language generation models may be fine-tuned using additional training data after an initial training to be able to make predictions on the additional training data.

Alternatively, because fine-tuning a language generation model is expensive and time-consuming, additional data may instead be provided as “context” within a prompt, and the language generation model may use the additional data to generate a response to the prompt without having to be fine-tuned on the additional data. A greater amount of additional data increases an accuracy of a response generated based on the additional data. However, language generation models have a context window, or a limit on an amount of data that can be accurately processed as a given input. If an input prompt exceeds a language generation model's context window, then a response generated based on the prompt may be inaccurate.

### SUMMARY

Systems and methods are described for language generation processing optimization by generating sub-batches of context examples and a user query, and generating a response to the query based on the sub-batches. In one example, in response to receiving a user query, a set of context example pairs including example queries and example responses are identified. The set of context example pairs are split into at least two groups, and the user query is appended to each of the at least two groups. A language generation model generates a response to the user query based on the at least two groups.

Using the set of context example pairs increases an accuracy of the response and allows the expense of fine-tuning the language generation model on the context example pairs to be avoided. Furthermore, because the set of context example pairs are split into the at least two groups, a size of the at least two groups can be tailored to fit within a context window of the language generation model, therefore allowing the language generation model to use a total amount of context data that may otherwise exceed the context window.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 shows an example of a query processing system according to aspects of the present disclosure.

FIG. 2 shows an example of a method for generating a response to a query according to aspects of the present disclosure.

FIG. 3 shows an example of a query processing system for generating a response to a query using a sub-batching process according to aspects of the present disclosure.

FIG. 4 shows an example of self-attention mechanism computations for sub-batched context examples

FIG. 5 shows an example of a transformer according to aspects of the present disclosure.

FIG. 6 shows an example of a method for generating a response to a user query based on a set of context examples according to aspects of the present disclosure.

FIG. 7 shows an example of a method for generating input embeddings according to aspects of the present disclosure.

FIG. 8 shows an example of a method for normalizing input embeddings according to aspects of the present disclosure.

FIG. 9 shows an example of a query processing apparatus according to aspects of the present disclosure.

### DETAILED DESCRIPTION

### Overview

Language generation models, such as large language models (LLMs), are machine learning models that are trained to predict a text output in response to an input prompt. The accuracy of LLM predictions is increased if the prompt relates to data that is used to train the language generation model. However, training an LLM is expensive and time consuming. Therefore, embodiments of the present disclosure enable accurate responses to queries by including additional training examples in the query itself. In some embodiments, the additional examples are divided into batches based on a context window of the model, and each batch is concatenated with the original query.

That is, additional data may instead be provided as context within the prompt, and the language generation model may use the additional data to generate an accurate response to the prompt without having to be fine-tuned on the additional data. Most language generation models have a context window, or a limit on the amount of data that can be accurately processed as a given input. If the input prompt exceeds a language generation model's context window, then the language generation model may not be able to accurately process the prompt, and a response generated based on the prompt may therefore be inaccurate.

Accordingly, systems and methods are described for language generation processing optimization by generating sub-batches of context examples and a user query, and generating a response to the query based on the sub-batches. In one example, in response to receiving a user query, a set of context example pairs including example queries and example responses are identified. The set of context example pairs are split into at least two groups, and the user query is appended to each of the at least two groups to generate at least two inputs. A language generation model generates a response to the user query based on the at least two inputs.

Using the set of context example pairs increases an accuracy of the response and allows the expense of fine-tuning the language generation model on the context example pairs to be avoided. Furthermore, because the set of context example pairs are split into the at least two groups, a size of the at least two inputs can be tailored to fit within a context window of the language generation model, therefore allowing the language generation model to use a total amount of context data that may otherwise exceed the context window. Accordingly, the language generation model can use a larger amount of additional data as input for in-context learning than other language generation models, and therefore the query processing system provides more accurate responses than other data processing systems that use in-context learning, while being more efficient than data processing systems that instead rely on fine-tuning a language generation model.

Additionally, according to some aspects, an accuracy of the response is further increased by performing mesa-optimization on the least two groups. Mesa-optimization is an inference-time approximation of a gradient descent update of weights of a machine learning model as would occur during fine-tuning. Performing a mesa-optimization process on the at least two groups therefore increases an accuracy of a response generated based on the at least groups while avoiding the expense of fine-tuning the language generation model.

### Terminology Examples

According to some aspects, a “language generation model” is a machine learning model trained to generate text in response to an input. An example language generation model comprises a large language model. An example large language model comprises one or more neural networks trained to understand and generate human-like text based on large amounts of data. A large language model learns patterns and structures of human language by analyzing input text data.

A “user query” refers to a text string. A “context example” refers to additional data that is provided as input to a language generation model. In some embodiments, a context example includes a query-response pair. A “query-response pair” refers to a stored query and a stored response to the stored query. An example of a query-response pair is the query “How many segments of users are identifiable in this set of data” and the response “There are 10 segments of users in the set of users.” A “domain” refers to a data that is especially relevant to a particular task.

An “embedding” refers to a representation of an object (e.g., the natural language query) in a lower-dimensional space such that semantic information about the object is more easily captured and analyzed by a machine learning model. For example, the embedding is a numerical representation of the object in a continuous vector space in which objects that include similar semantic information to each other correspond to vectors that are numerically similar to and thus “closer” to each other, thereby allowing a similarity between different objects corresponding to different embeddings to be readily determined. A “natural language query embedding” refers to an embedding of the natural language query, e.g., a representation of the natural language query in an embedding space. An “embedding space” (or a “vector space”) refers to a set having embeddings (or vectors) as elements, and is characterized by a dimension specifying a number of independent directions in the embedding space.

An example of a query processing system according to the present disclosure is used in a user experience platform (UEP) chatbot context. In the example, a user provides a query “How can I import audiences' data?” to the UEP chatbot. The query processing system identifies a set of n (e.g., 32) query-response pairs that relate to information included in a profile for the user. An example query of the query response pair is “How many segments of users are identifiable in this set of data” and an example response of the query-response pair is “There are 10 segments of users in the set of users.”

The query processing system divides the set of n query-response pairs into k (e.g., 4) groups, each including an equal number of query-response pairs, and appends the user query to each of the k groups to obtain k inputs. The query processing system adds padding tokens to one or more of the inputs, if needed, such that each input includes an equal number of tokens. An example input therefore includes a text string including eight of the query-response pairs appended to the user query.

A language generation model of the query processing system processes each of the inputs in parallel, and generates a response to the query based on the inputs. Processing the inputs in parallel allows all of the context example pairs to be used as context without exceeding the context window of the language generation model. The UEP chatbot then displays the response to the user.

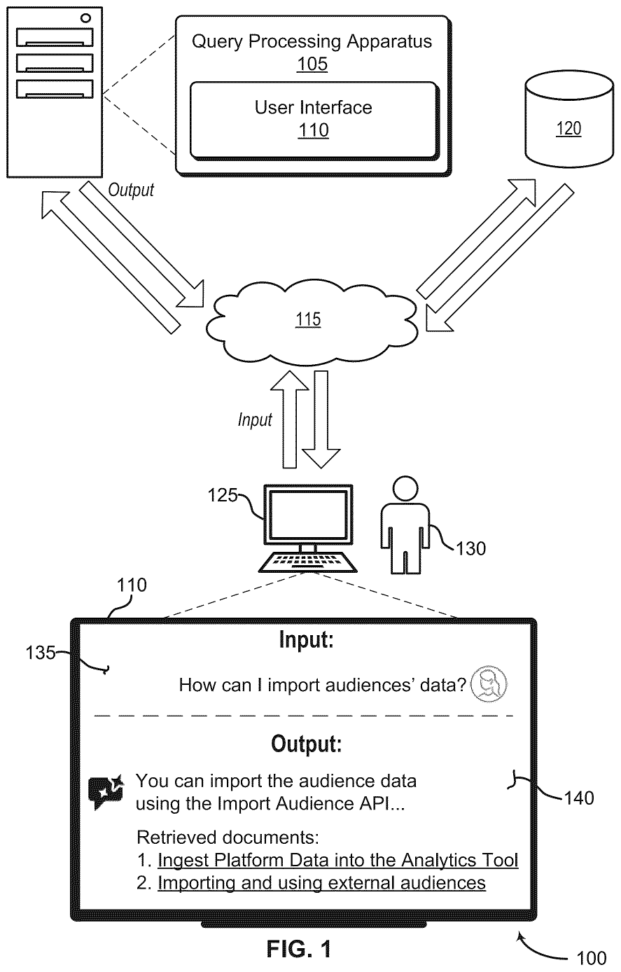

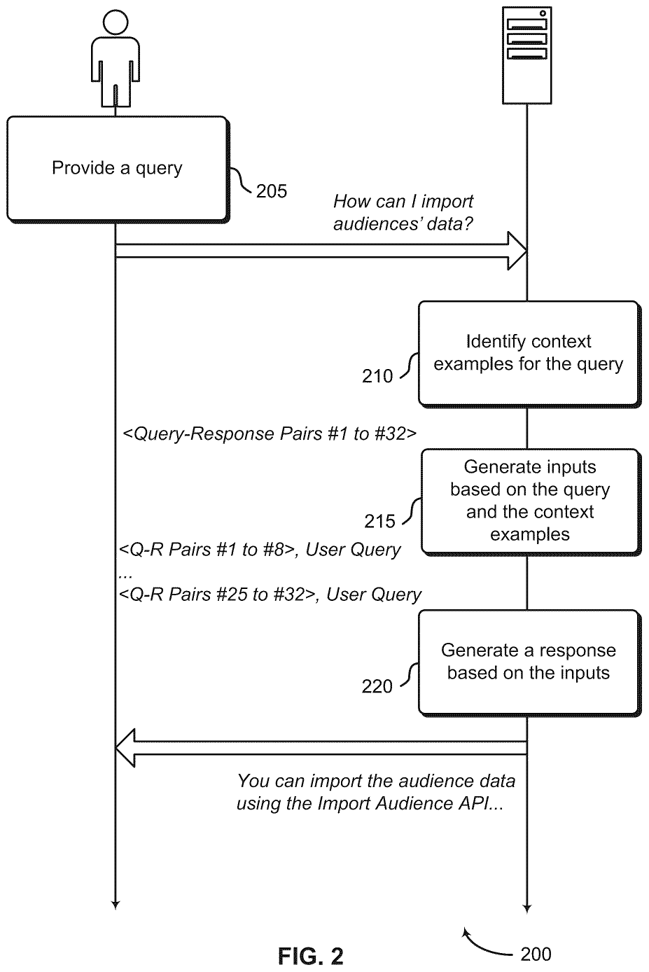

Further example applications of the present disclosure are provided with reference to FIGS. 1 and 2. Details regarding the architecture of the query processing system are provided with reference to FIGS. 1, 3-5, and 9. Examples of a process for generating a response to a user query based on multiple inputs are provided with reference to FIGS. 2 and 6-8.

### Query Processing System

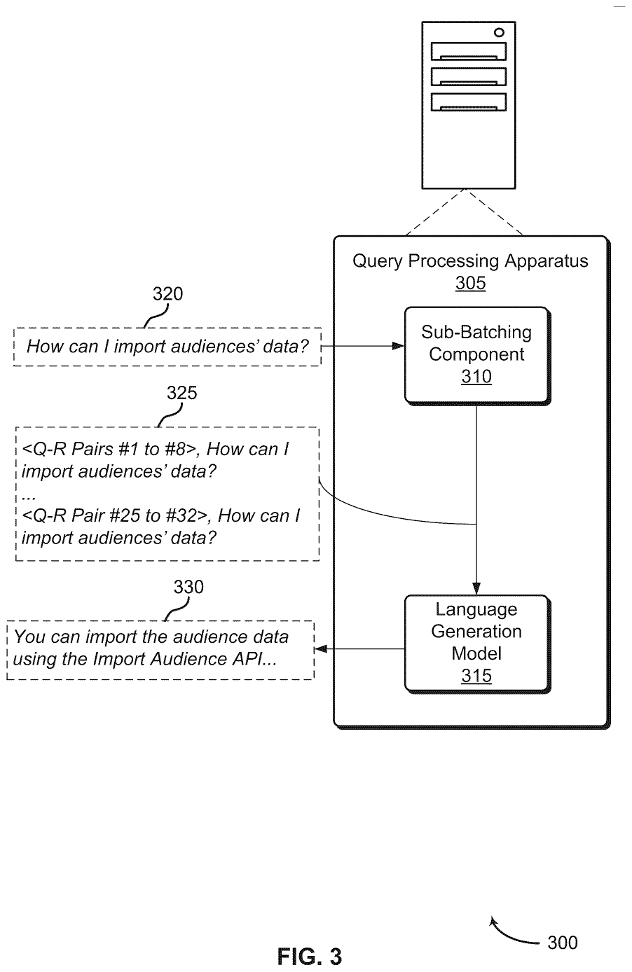

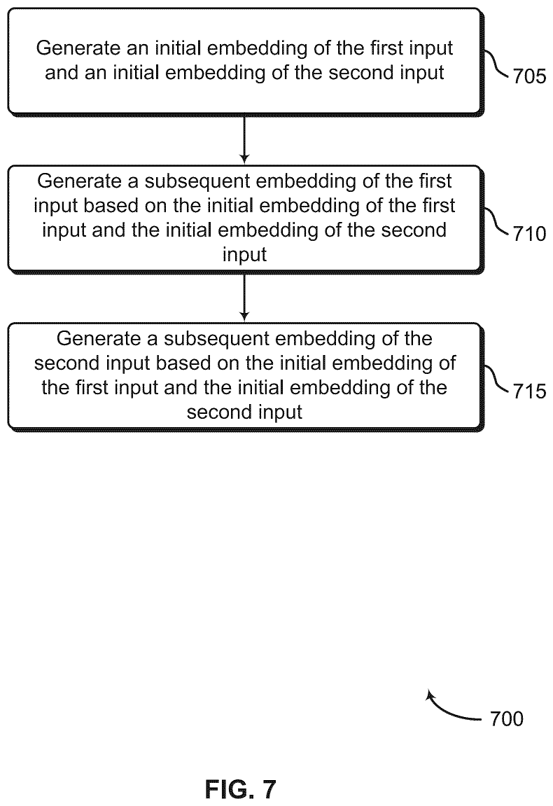

FIG. 1 shows an example of a query processing system 100 according to aspects of the present disclosure. The example shown includes query processing system 100, user device 125, user 130, query 135, and response 140. Query processing system 100 is an example of, or includes aspects of, the corresponding element described with reference to FIGS. 3 and 7. In one aspect, query processing system 100 includes query processing apparatus 105, cloud 115, and database 120. In one aspect, query processing apparatus 105 includes user interface 110. Query 135 and response 140 are examples of, or include aspects of, the corresponding elements described with reference to FIG. 3.

In the example of FIG. 1, a user (e.g., user 130) provides a query (e.g., query 135, “How can I import audiences' data?”) to query processing apparatus 105 via user interface 110 displayed on a user device (e.g., user device 125) by query processing apparatus 105. Query processing apparatus 105 retrieves a set of context examples from database 120 based on one or more of characteristics associated with the user, a domain of the query, a similarity between the query and queries included in the set of context examples, or another criteria.

Query processing apparatus 105 divides the set of context examples into at least two groups, and appends the query to each of the at least two groups to generate at least two inputs. Query processing apparatus 105 provides the at least two inputs to a language generation model (e.g., the language generation model 315 described with reference to FIG. 3), and the language generation model generates a response to the query (e.g., response 140, “You can import the audience data using the Import Audience API . . . ”, and hyperlinks to two relevant retrieved documents) based on the at least two inputs. User interface 110 displays the response to the user.

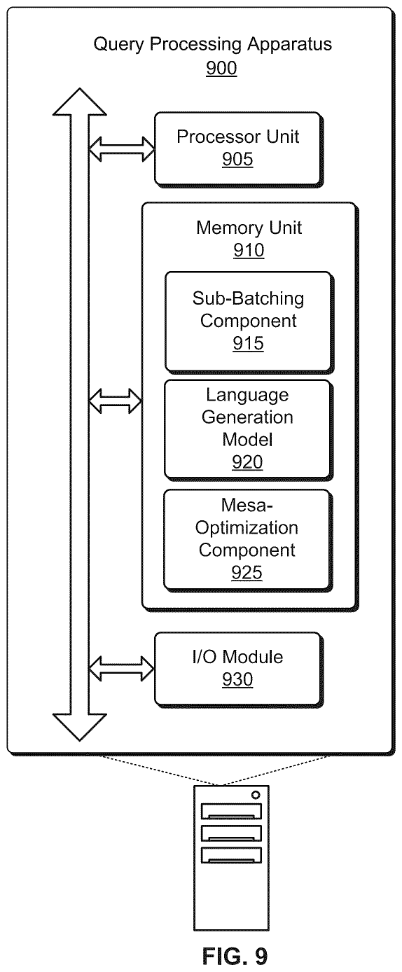

Query processing apparatus 105 is an example of, or includes aspects of, the corresponding element described with reference to FIGS. 3 and 9. According to some aspects, query processing apparatus 105 includes a computer-implemented network. In some embodiments, the computer-implemented network includes a machine learning model (such as the language generation model 315 described with reference to FIG. 3). In some embodiments, query processing apparatus 105 also includes at least one processor, a memory subsystem, a communication interface, an I/O interface, at least one user interface component, and a bus. Additionally, in some embodiments, query processing apparatus 105 communicates with user device 125 and database 120 via cloud 115.

According to some aspects, query processing apparatus 105 is implemented on a server. A server provides at least one function to users linked by way of one or more of various networks, such as cloud 115. The server may include a microprocessor board that includes a microprocessor responsible for controlling aspects of the server. The server may use a microprocessor to exchange data with other devices or users on one or more of the networks via at least one protocol, such as hypertext transfer protocol (HTTP), simple mail transfer protocol (SMTP), file transfer protocol (FTP), simple network management protocol (SNMP), and the like.

According to some aspects, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Further detail regarding the architecture of query processing apparatus is provided with reference to FIGS. 1, 3-5, and 9. Further detail regarding a process for generating a response to a user query based on multiple inputs is provided with reference to FIGS. 2 and 6-8.

Cloud 115 is a computer network configured to provide on-demand availability of computer system resources, such as data storage and computing power. In some examples, cloud 115 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some examples, cloud 115 is limited to a single organization. In other examples, cloud 115 is available to many organizations.

In one example, cloud 115 includes a multi-layer communications network comprising multiple edge routers and core routers. In another example, cloud 115 is based on a local collection of switches in a single physical location. According to some aspects, cloud 115 provides communications between user device 125, query processing apparatus 105, and database 120.

A database, such as database 120, is an organized collection of data. In an example, database 120 stores data in a specified format known as a schema. According to some aspects, database 120 is structured as a single database, a distributed database, multiple distributed databases, or an emergency backup database. Data storage and processing in database 120 is manageable by a database controller, which can be operated by a user or automatically without interaction from the user. In some examples, database 120 is external to query processing apparatus 105 and communicates with query processing apparatus 105 via cloud 115. In other examples, database 120 is included in query processing apparatus 105.

According to some aspects, user device 125 is a personal computer, laptop computer, mainframe computer, palmtop computer, personal assistant, mobile device, or any other suitable processing apparatus. In some examples, user device 125 includes software that displays user interface 110 (e.g., a graphical user interface, a text-based interface, or a combination thereof) provided by query processing apparatus 105. In some aspects, the user interface allows information to be communicated between user 130 and query processing apparatus 105.

According to some aspects, a user device user interface enables the user to interact with user device 125. The user device user interface may include an audio device, such as an external speaker system, an external display device such as a display screen, or an input device (e.g., a remote-control device interfaced with the user interface directly or through an I/O controller module). The user device user interface may include a graphical user interface, a text-based interface, or a combination thereof.

FIG. 2 shows an example of a method for generating a response to a query according to aspects of the present disclosure. Referring to FIG. 2, a user provides a query to a query processing apparatus (e.g., the query processing apparatus 105 described with reference to FIG. 1). The query processing apparatus identifies a set of pairs of example queries and responses that relate to the user. The query processing apparatus divides the set of pairs of example queries and responses into groups, each including an equal number of pairs, and appends the user query to each of the groups to obtain inputs. The query processing apparatus adds padding tokens to one or more of the inputs, if needed, such that each input includes an equal number of tokens.

A language generation model of the query processing apparatus (e.g., the language generation model 315 described with reference to FIG. 3) processes each of the inputs in parallel, and generates a response to the query based on the inputs. Processing the groups in parallel allows all of the context example pairs to be used as context without exceeding the context window of the language generation model. The query processing apparatus then displays the response to the user.

At operation 205, a user provides a query. In some cases, the operations of this step refer to, or are performed by, a user as described with reference to FIG. 1. In an example, the user provides the query (e.g., “How can I important audiences' data?”) to a user interface (e.g., the user interface 110 described with reference to FIG. 1) displayed by the query processing apparatus on a user device (e.g., the user device described with reference to FIG. 1).

At operation 210, the system identifies context examples for the query. In some cases, the operations of this step refer to, or are performed by, a query processing apparatus as described with reference to FIGS. 1, 3, and 9. In the example of FIG. 2, the set of context examples includes 32 query-response pairs. In an example, the set of context examples includes a total number of tokens that exceeds a context window of the language generation model.

In one example, the query processing apparatus identifies characteristics associated with the user (such as user profile information, a user role, etc.) and retrieves a set of context examples from a database (such as the database 120 described with reference to FIG. 1) associated with the characteristics. In another example, the query processing apparatus analyzes interaction data of the user with the user interface (e.g., a chat history) to identify a domain of the interaction data, and retrieves a set of context examples associated with the domain from the database. In another example, the query processing apparatus retrieves a set of context examples including queries that are similar to the query (for example, by generating an embedding of the query and comparing the query embedding to embeddings of the context examples). In another example, the set of context examples is predetermined.

At operation 215, the system generates inputs based on the query and the context examples. In some cases, the operations of this step refer to, or are performed by, a query processing apparatus as described with reference to FIGS. 1, 3, and 9. In an example, the query processing apparatus generates four inputs, where the first input includes query-response pairs numbers 1 to 8 appended to the query, the second input includes query-response pairs numbers 9 to 16 appended to the query, the third input includes query-response pairs numbers 17 to 24 appended to the query, and the fourth input includes query-response pairs numbers 25 to 32 appended to the user query.

At operation 220, the system generates a response to the query based on the inputs. In some cases, the operations of this step refer to, or are performed by, a query processing apparatus as described with reference to FIGS. 1, 3, and 9. In an example, the query processing apparatus provides the four inputs to the language generation model, and the language generation model generates the response (e.g., “You can import the audience data using the Import Audience API . . . ”) based on the four inputs.

FIG. 3 shows an example of a query processing system 300 for generating a response to a query using a sub-batching process according to aspects of the present disclosure. The example shown includes query processing system 300, user query 320, set of inputs 325, and response 330. In one aspect, query processing system 300 includes query processing apparatus 305. In one aspect, query processing apparatus 305 includes sub-batching component 310 and language generation model 315.

Referring to FIG. 3, query processing system 300 generates a response to a user query by generating a set of inputs, or sub-batches, from a set of context examples including query-response pairs, combing each of the sub-batches with the user query, and generating the response by processing the sub-batches using language generation model 315.

According to some aspects, query processing apparatus 305 obtains a user query (e.g., user query 320, “How can I import audiences' data?”) and a set of context examples. In some aspects, each of the set of context examples includes a query-response pair. In some aspects, the user query includes text corresponding to a domain of the set of context examples. In the example of FIG. 3, sub-batching component obtains 32 context examples (for example, from a database such as the database described with reference to FIG. 1).

According to some aspects, sub-batching component 310 generates a first input and a second input, where the first input includes the user query appended to a first portion of the set of context examples, and the second input includes the user query appended to a second portion of the set of context examples. In the example of FIG. 3, sub-batching component 310 generates four inputs (e.g., set of inputs 325), where each of the four inputs includes 8 of the 32 content examples.

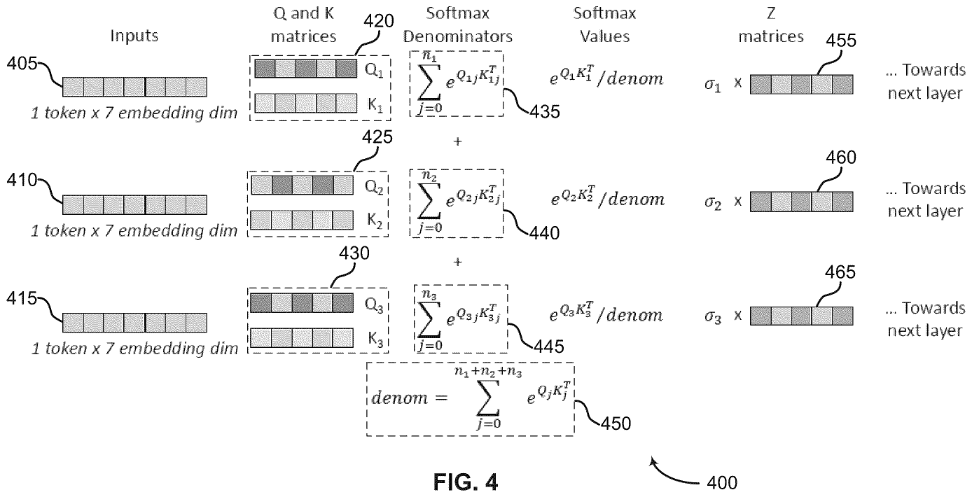

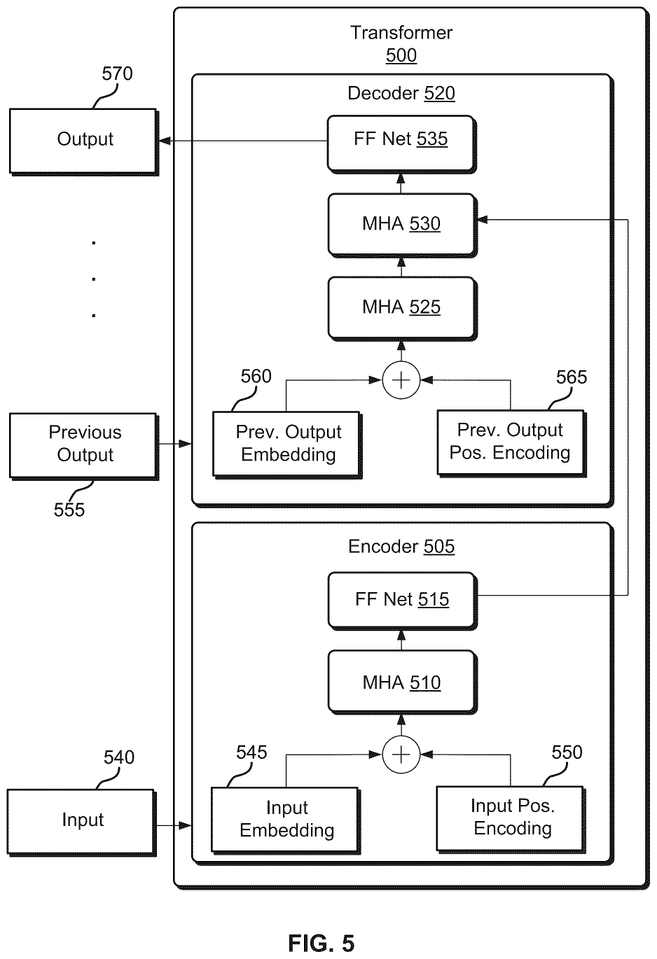

According to some aspects, language generation model 315 generates a response (e.g. response 330, “You can import the audience data using the Import Audience API . . . ”) to the user query based on the first input and the second input. In some examples, language generation model processes the first input and the second input in parallel (e.g., logically parallel). In some embodiments, language generation model 315 comprises one or more transformers (e.g., the transformer 500 described with reference to FIG. 5) that employ an attention mechanism as described with reference to FIG. 4 to process the inputs in parallel.

According to some aspects, a transformer comprises one or more artificial neural networks (ANNs) comprising attention mechanisms that enable the transformer to weigh an importance of different words or tokens within a sequence. In some examples, a transformer processes entire sequences simultaneously in parallel, making the transformer highly efficient and allowing the transformer to capture long-range dependencies more effectively.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

The self-attention mechanism allows the transformer to focus on different parts of an input sequence while computing representations for the input sequence. The self-attention mechanism captures relationships between words of a sequence by assigning attention weights to each word based on a relevance to other words in the sequence, thereby enabling the transformer to model dependencies regardless of a distance between words.

Query processing system 300 is an example of, or includes aspects of, the corresponding element described with reference to FIGS. 1 and 7. Query processing apparatus 305 is an example of, or includes aspects of, the corresponding element described with reference to FIGS. 1 and 9. Sub-batching component 310 and language generation model 315 are examples of, or include aspects of, the corresponding elements described with reference to FIG. 9. User query 320 and response 330 are examples of, or include aspects of, the corresponding elements described with reference to FIG. 1.

FIG. 4 shows an example 400 of self-attention mechanism computations for sub-batched context examples according to aspects of the present disclosure. Referring to FIG. 4, an attention mechanism enables an ANN (e.g., the language generation model 315 as described with reference to FIG. 3) to selectively focus on different parts of an input sequence, assigning varying degrees of importance or attention to each part. The attention mechanism achieves the selective focus by considering a relevance of each input element with respect to a current state of the ANN.

In a self-attention mechanism, each element in a sequence (for instance, a word in a sentence) is first represented as a vector. The vectors are generated from embeddings that capture semantic information about the elements. For each element in the sequence, a query (Q) vector, a key (K) vector, and a value (V) vector are computed. The query represents the “question” an element asks about others in the sequence, while the key corresponds to the “answer” to that question, and the value holds the actual information that will be passed forward in the ANN. The vectors are derived by multiplying the input vector by learned weight matrices.

To determine how much attention one element should pay to another, the self-attention mechanism calculates a score by taking the dot product between the query of one element and the key of another. This score indicates how much relevance or “attention” the first element should give to the second. To maintain numerical stability and prevent excessively large values from distorting the results, the score may be scaled by dividing the score by the square root of the dimensionality of the key vectors. This scaling step ensures that the values remain manageable.

The scores are passed through a softmax function that normalizes the scores into a probability distribution, ensuring that the scores for each element add up to one and reflect the relative importance of each element's value in relation to the current element.

After normalizing the scores, a weighted sum of value vectors is computed for each element. The weighted sum is the output for each element, where the weights correspond to the scores, effectively aggregating context from other elements in the sequence based on their relevance. The weighted sum of the element therefore reflects relationships that the element has with all other elements in the sequence.

Self-attention is often performed using multiple parallel “heads” in what is known as multi-head attention. Each head learns different aspects of the relationships between elements, allowing the ANN to capture various contextual nuances. The outputs from all attention heads are then concatenated and linearly transformed to produce a final representation.

The self-attention mechanism provides an ability to capture long-range dependencies between elements in a sequence. Since the entire sequence can be processed simultaneously rather than sequentially, it also allows for efficient parallelization. Additionally, because each element can attend to all others, the ANN is better equipped to learn complex relationships, making self-attention highly scalable and effective for tasks that require deep contextual understanding.

For example, in a sentence like “The cat sat on the mat,” the word “cat” can attend to “sat,” “on,” “mat,” and “the,” enabling the ANN to understand the relationships between these words and how they contribute to the overall meaning of the sentence. The self-attention mechanism allows the ANN to dynamically adjust how much focus each element should have on every other element in a sequence, capturing complex dependencies and relationships.

Given a sentence of [symbol] sequence length, the attention mechanism creates [symbol] matrices of a size [symbol] ×d, where d is the hidden dimension. Then the query matrix, Q, is multiplied with the transpose of the key matrix, KT. This operation has quadratic complexity in terms of the sequence length [symbol] . After another multiplication, a Z matrix is obtained, which becomes an intermediate input for a next layer. A reduction in the computation done for the softmax function allows more tokens to be incorporated, and hence more context examples, to be incorporated.

Accordingly, given a set of i inputs (where i=3 in the example of FIG. 4) for a user query, the self-attention mechanism of the language generation model uses [symbol] /i tokens and computes the Q and K matrices separately for each input and computes softmax denominators for the softmax calculation separately. Taking a sum of the computations to get the softmax values of each of the inputs results in i matrices rather than one, and each Z matrix gets sent to the next layer of the language generation model. Therefore, unlike how softmax values are computed traditionally, a Q matrix of one input is not multiplied with K matrices of other inputs.

In the example of FIG. 4, the language generation model generates an initial embedding 405 of a first input, an initial embedding 410 of a second input, and an initial embedding 415 of a third input, where the first input, the second input, and the third input respectively include three exclusive portions of a set of context examples, each appended to a same user query.

The language generation model generates a subsequent embedding 455 of the first input, a subsequent embedding 460 of the second input, and a subsequent embedding 465 of the third input (e.g., Z matrices) based on the initial embedding 405 of the first input, the initial embedding 410 of the second input, and the initial embedding 415 of the third input.

The language generation model generates a first normalization value 435 based on the initial embedding 405 of the first input, a second normalization value 440 based on the based on the initial embedding 410 of the second input, and a third normalization value 445 based on the initial embedding 415 of the third input. The language generation model determines a combined normalization value 450 (e.g., a softmax denominator) based on the first normalization value 435, the second normalization value 440, and the third normalization value 445, where the subsequent embedding 455 of the first input, the subsequent embedding 460 of the second input, and the subsequent embedding 465 of the third input are generated based on the combined normalization value 450.

The language generation model computes a first set of attention components 420 (e.g., Q and K matrices) based on the initial embedding 405 of the first input, where the first normalization value 435 is based on the first set of attention components 420. Likewise, the language generation model computes a second set of attention components 425 based on the initial embedding 410 of the second input and a third set of attention components 430 based on the initial embedding 415 of the third input, where the second normalization value 440 is based on the second set of attention components 425 and the third normalization value 445 is based on the third set of attention components 430.

FIG. 5 shows an example of a transformer according to aspects of the present disclosure. The example shown includes transformer 500, encoder 505, decoder 520, input 540, input embedding 545, input positional encoding 550, previous output 555, previous output embedding 560, previous output positional encoding 565, and output 570. According to some aspects, transformer 500 is an example of a transformer that is implemented in the language generation model 315 described with reference to FIG. 3.

In the example of FIG. 5, encoder 505 includes multi-head self-attention sublayer 510 and feed-forward network sublayer 515. Decoder 520 includes first multi-head self-attention sublayer 525, second multi-head self-attention sublayer 530, and feed-forward network sublayer 535.

Encoder 505 is configured to map input 540 to a sequence of continuous representations that are fed into decoder 520. Decoder 520 generates output 570 (e.g., a prediction of an output sequence of words or tokens) based on the output of encoder 505 and previous output 555 (e.g., a previously predicted output sequence), which allows for the use of autoregression.

Encoder 505 parses input 540 into tokens and vectorizes the parsed tokens to obtain input embedding 545, and adds input positional encoding 550 (e.g., positional encoding vectors for input 540 of a same dimension as input embedding 545) to input embedding 545. Input positional encoding 550 includes information about relative positions of words or tokens in input 540.

Encoder 505 comprises one or more encoding layers (e.g., six encoding layers) that generate contextualized token representations, where each representation corresponds to a token that combines information from other input tokens via self-attention mechanism. Each encoding layer of encoder 505 comprises a multi-head self-attention sublayer (e.g., multi-head self-attention sublayer 510). The multi-head self-attention sublayer implements a multi-head self-attention mechanism that receives different linearly projected versions of queries, keys, and values to produce outputs in parallel. Each encoding layer of encoder 505 also includes a fully connected feed-forward network sublayer (e.g., feed-forward network sublayer 515) comprising two linear transformations surrounding a Rectified Linear Unit (ReLU) activation:

$$F F N ( x ) = R e L U ( {W}_{1} x + {b}_{1} ) {W}_{2} + {b}_{2} \qquad ( 1 )$$

Each layer employs different weight parameters (W₁, W₂) and different bias parameters (b₁, b₂) to apply a same linear transformation to each word or token in input 540.

Each sublayer of encoder 505 is followed by a normalization layer that normalizes a sum computed between a sublayer input x and an output sublayer(x) generated by the sublayer:

$$layernorm ( x + sublayer ( x ) ) \qquad ( 2 )$$

Encoder 505 is bidirectional because encoder 505 attends to each word or token in input 540 regardless of a position of the word or token in input 540.

Decoder 520 comprises one or more decoding layers (e.g., six decoding layers). Each decoding layer comprises three sublayers including a first multi-head self-attention sublayer (e.g., first multi-head self-attention sublayer 525), a second multi-head self-attention sublayer (e.g., second multi-head self-attention sublayer 530), and a feed-forward network sublayer (e.g., feed-forward network sublayer 535). Each sublayer of decoder 520 is followed by a normalization layer that normalizes a sum computed between a sublayer input x and an output sublayer(x) generated by the sublayer.

Decoder 520 generates previous output embedding 560 of previous output 555 and adds previous output positional encoding 565 (e.g., position information for words or tokens in previous output 555) to previous output embedding 560. Each first multi-head self-attention sublayer receives the combination of previous output embedding 560 and previous output positional encoding 565 and applies a multi-head self-attention mechanism to the combination.

Each second multi-head self-attention sublayer implements a multi-head self-attention mechanism similar to the multi-head self-attention mechanism implemented in each multi-head self-attention sublayer of encoder 505 by receiving a query Q from a previous sublayer of decoder 520 and a key K and a value V from the output of encoder 505.

Each feed-forward network sublayer implements a fully connected feed-forward network similar to feed-forward network sublayer 515. The feed-forward network sublayers are followed by a linear transformation and a softmax to generate a prediction of output 570 (e.g., a prediction of a next word or token in a sequence of words or tokens).

### Query Processing

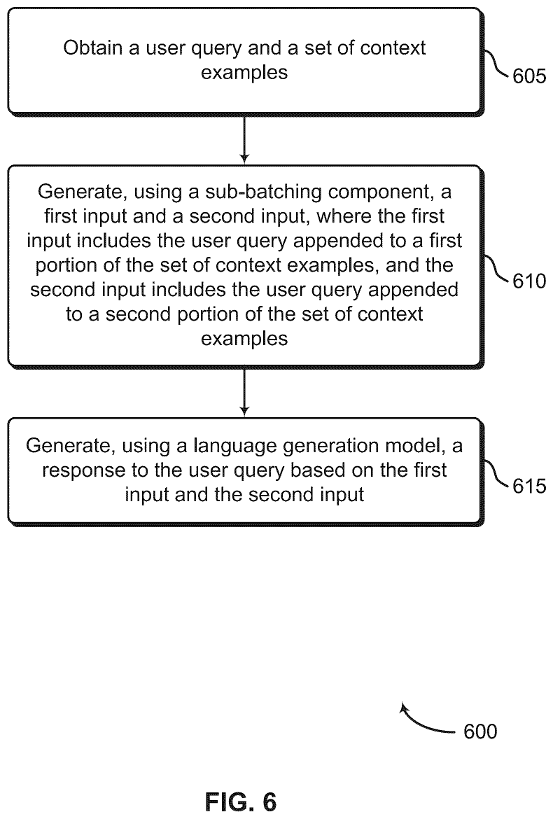

FIG. 6 shows an example of a method 600 for generating a response to a user query based on a set of context examples according to aspects of the present disclosure. Referring to FIG. 6, a query processing apparatus (such as the query processing apparatus 900 described with reference to FIG. 9) generates a response to a user query by obtaining a set of context examples, generating at least two inputs by appending the user query to each of a first portion of the set of context examples and a second portion of the set of context examples, and generating the response based on the at least two inputs using a language generation model (such as the language generation model 920 described with reference to FIG. 9).

Generating the response based on the inputs including the portions of the context examples (i.e., performing in-context learning) using the language generation model is more computationally efficient than fine-tuning the language generation model based on the context examples. Furthermore, dividing the context examples into the at least two portions allows the language generation model to use a large number of context examples without exceeding a context window of the language generation model, thereby increasing an accuracy of the response.

At operation 605, the system obtains a user query and a set of context examples. In some cases, the operations of this step refer to, or are performed by, a query processing apparatus as described with reference to FIGS. 1, 3, and 9. In some embodiments, each of the plurality of context examples comprises a query-response pair. In some embodiments, the user query comprises text corresponding to a domain of the plurality of context examples. In some embodiments, the query processing apparatus determines a context window of the language generation model and obtains the set of context examples in response to the determination.

In an example, a user provides the query to a user interface displayed by the query processing apparatus on a user device. In one example, the query processing apparatus identifies characteristics associated with the user (such as user profile information, a user role, etc.) and retrieves a set of context examples from a database associated with the characteristics. In another example, the query processing apparatus analyzes interaction data of the user with the user interface (e.g., a chat history) to identify a domain of the previous interaction history, and retrieves a set of context examples associated with the domain from the database. In another example, the query processing apparatus retrieves a set of context examples including queries that are similar to the query (for example, by generating an embedding of the query and comparing the query embedding to embeddings of the context examples). In another example, the set of context examples is independent of the query or the user.

At operation 610, the system generates, using a sub-batching component, a first input and a second input, where the first input includes the user query appended to a first portion of the set of context examples, and the second input includes the user query appended to a second portion of the set of context examples. In some cases, the operations of this step refer to, or are performed by, a sub-batching component as described with reference to FIGS. 3 and 9.

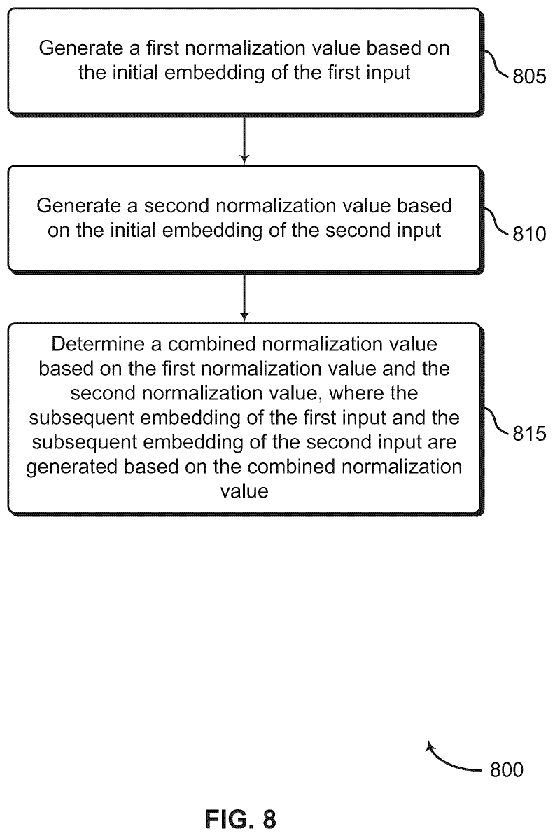

At operation 615, the system generates, using a language generation model, a response to the user query based on the first input and the second input. In some cases, the operations of this step refer to, or are performed by, a language generation model as described with reference to FIGS. 3 and 9. In an example, the language generation model generates the response as described with reference to FIGS. 8-9.

According to some aspects, generating the response to the user query includes performing mesa-optimization based on the first input and the second input. Mesa-optimization is an inference-time approximation of a gradient descent update of weights of a machine learning model as would occur during fine-tuning. Performing a mesa-optimization process on the at least two groups therefore increases an accuracy of a response generated based on the at least groups while avoiding the expense of fine-tuning the language generation model.

During training of a machine learning model, a forward pass starts with some initial weights, and then a series of new weights is obtained via successive applications of gradient descent. According to some aspects, the language generation model performs in-context learning during inference by treating activations (e.g., outputs of neurons) as weights of a model, and using layers of the model to perform a series of updates to those activations. Accordingly, the language generation model is a mesa-optimizer, or a model discovered during training that is itself an optimizer of a separate objective.

Therefore, according to some aspects, instead of optimizing weights of the language generation model as occurs in a fine-tuning process, the context examples in an activation space are optimized. For example, for a linear operation that occurs in a self-attention layer, a step of gradient descent may be considered as update to context examples, rather than an update to the weights:

$${y}_{0} = {W}_{0} x ⇒ {y}^{*} = {W}^{*} x \qquad ( 3 )$$

$$∴ y = {y}^{*} - {y}_{0} ⇒ Δ W x = ( {W}^{*} - {W}_{0} ) x \qquad ( 4 )$$

As shown in Equation 4, a change in outputs is analogous to a change in weights, and a move in input activations according to ground truths is equivalent to changing weights towards an optimum. Therefore, according to some aspects, each query of the query-response pairs of the context examples is encoded by the language generation model. The query encodings are optimized using generated responses and the responses of the query-response pairs in an auto-regressive fashion. For example, a decoder of the language generation model generates predicted words based on the encoded queries. Given the responses of the query-response pairs as a ground truth, a mesa-optimization component (such as the mesa-optimization component described with reference to FIG. 9) updates the query encodings such that the generated predicted words are closer to the responses of the query-response pairs, respectively. The updated query encodings are then used to generate the response to the user query.

FIG. 7 shows an example of a method for generating input embeddings according to aspects of the present disclosure. At operation 705, the system generates an initial embedding of the first input and an initial embedding of the second input. In some cases, the operations of this step refer to, or are performed by, a language generation model as described with reference to FIGS. 3 and 9. In an example, the language generation model generates the initial embeddings as described with reference to FIG. 4.

At operation 710, the system generates a subsequent embedding of the first input based on the initial embedding of the first input and the initial embedding of the second input. In some cases, the operations of this step refer to, or are performed by, a language generation model as described with reference to FIGS. 3 and 9. In an example, the language generation model generates the subsequent embedding as described with reference to FIGS. 4 and 8.

At operation 715, the system generates a subsequent embedding of the second input based on the initial embedding of the first input and the initial embedding of the second input. In some cases, the operations of this step refer to, or are performed by, a language generation model as described with reference to FIGS. 3 and 9. In an example, the language generation model generates the subsequent embedding as described with reference to FIGS. 4 and 8.

FIG. 8 shows an example of a method for normalizing input embeddings according to aspects of the present disclosure. At operation 805, the system generates a first normalization value based on the initial embedding of the first input. In some cases, the operations of this step refer to, or are performed by, a language generation model as described with reference to FIG. 3. In an example, the language generation model generates the first normalization value as described with reference to FIG. 4. In an example, the language generation model computes a first set of attention components based on the initial embedding of the first input, where the first normalization value is based on the first set of attention components.

At operation 810, the system generates a second normalization value based on the initial embedding of the second input. In some cases, the operations of this step refer to, or are performed by, a language generation model as described with reference to FIGS. 3 and 9. In an example, the language generation model generates the second normalization value as described with reference to FIG. 4. In an example, the language generation model computes a second set of attention components based on the initial embedding of the second input, where the second normalization value is based on the second set of attention components.

At operation 815, the system determines a combined normalization value based on the first normalization value and the second normalization value, where the subsequent embedding of the first input and the subsequent embedding of the second input are generated based on the combined normalization value. In some cases, the operations of this step refer to, or are performed by, a language generation model as described with reference to FIGS. 3 and 9. In an example, the language generation model determines the combined normalization value as described with reference to FIG. 4. In an example, the combined normalization value comprises a softmax denominator.

Accordingly, a method, non-transitory computer readable medium, system, and apparatus for data processing is described. One or more aspects of the method, non-transitory computer readable medium, system, and apparatus include obtaining a user query and a plurality of context examples; generating, using a sub-batching component, a first input and a second input, wherein the first input comprises the user query appended to a first portion of the plurality of context examples, and the second input comprises the user query appended to a second portion of the plurality of context examples; and generating, using a language generation model, a response to the user query based on the first input and the second input.

In some aspects, each of the plurality of context examples comprises a query-response pair. In some aspects, the user query comprises text corresponding to a domain of the plurality of context examples.

In some examples, generating the response to the user query includes processing the first input and the second input in parallel. In some examples, generating the response to the user query includes include generating an initial embedding of the first input and an initial embedding of the second input. Some examples further include generating a subsequent embedding of the first input based on the initial embedding of the first input and the initial embedding of the second input. Some examples further include generating a subsequent embedding of the second input based on the initial embedding of the first input and the initial embedding of the second input.

Some examples of the method, non-transitory computer readable medium, system, and apparatus further include generating a first normalization value based on the initial embedding of the first input. Some examples further include generating a second normalization value based on the initial embedding of the second input. Some examples further include determining a combined normalization value based on the first normalization value and the second normalization value, wherein the subsequent embedding of the first input and the subsequent embedding of the second input are generated based on the combined normalization value.

Some examples of the method, non-transitory computer readable medium, system, and apparatus further include computing a first set of attention components based on the initial embedding of the first input, wherein the first normalization value is based on the first set of attention components. Some examples of the method, non-transitory computer readable medium, system, and apparatus further include computing a second set of attention components based on the initial embedding of the second input, wherein the second normalization value is based on the second set of attention components.

In some aspects, the combined normalization value comprises a softmax denominator. In some examples, generating the response to the user query includes performing mesa-optimization based on the first input and the second input.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Query Processing Apparatus

FIG. 9 shows an example of a query processing apparatus 900 according to aspects of the present disclosure. Query processing apparatus 900 is an example of, or includes aspects of, the corresponding element described with reference to FIGS. 1 and 3. Query processing apparatus 900 includes processor unit 905, memory unit 910, and I/O module 930. Memory unit 910 includes sub-batching component 915, language generation model 920, and mesa-optimization component 925. According to some aspects, one or more of sub-batching component 915 and mesa-optimization component 925 comprises executable code stored in memory unit 910. Additionally or alternatively, one or more of sub-batching component 915 and mesa-optimization component 925 comprises one or more hardware circuits of query processing apparatus 900, firmware of query processing apparatus 900, or a combination thereof. According to some aspects, language generation model 920 comprises machine learning parameters stored in memory unit 910.

Processor unit 905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 905 is configured to operate a memory array using a memory controller. In other cases, a memory controller is integrated into processor unit 905. In some cases, processor unit 905 is configured to execute computer-readable instructions stored in memory unit 910 to perform various functions. In some aspects, processor unit 905 includes special purpose components for modem processing, baseband processing, digital signal processing, or transmission processing.

Memory unit 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 905 to perform various functions described herein.

In some cases, memory unit 910 includes a basic input/output system (BIOS) that controls basic hardware or software operations, such as an interaction with peripheral components or devices. In some cases, memory unit 910 includes a memory controller that operates memory cells of memory unit 910. For example, the memory controller may include a row decoder, column decoder, or both. In some cases, memory cells within memory unit 910 store information in the form of a logical state.

According to some aspects, query processing apparatus 900 uses one or more processors of processor unit 905 to execute instructions stored in memory unit 910 to perform functions described herein. In an example, the query processing apparatus 900 performs operations comprising obtaining a user query and a plurality of context examples; generating, using a sub-batching component, a first input and a second input, wherein the first input comprises the user query appended to a first portion of the plurality of context examples, and the second input comprises the user query appended to a second portion of the plurality of context examples; and generating, using a language generation model, a response to the user query based on the first input and the second input.

In some embodiments, the language generation model 920 is an artificial neural network (ANN) such as the transformer 500 described with reference to FIG. 5. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the language generation model 920 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Parameters of the language generation model 920 can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the language generation model 920 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the language generation model 920 can be used to make predictions on new, unseen data (i.e., during inference).

I/O module 930 receives inputs from and transmits outputs of the query processing apparatus 900 to other devices or users. For example, I/O module 930 receives inputs for the language generation model 920 and transmits outputs of the language generation model 920.

The description and drawings described herein represent example configurations and do not represent all the implementations within the scope of the claims. For example, the operations and steps may be rearranged, combined or otherwise modified. Also, in some embodiments, structures and devices are represented in the form of block diagrams to represent the relationship between components and avoid obscuring the described concepts. In some embodiments, similar components or features have the same name but have different reference numbers corresponding to different figures.

Some modifications to the disclosure may be readily apparent to those skilled in the art, and the principles defined herein are applicable to other variations without departing from the scope of the disclosure. Thus, the disclosure is not limited to the examples and designs described herein, but is to be accorded the broadest scope consistent with the principles and novel features disclosed herein.

According to some aspects, the functions described herein are implemented in hardware or software and are executed by a processor, firmware, or any combination thereof. In some embodiments, if implemented in software executed by a processor, the functions are stored in the form of instructions or code on a computer-readable medium.

Computer-readable media includes both non-transitory computer storage media and communication media including any medium that facilitates transfer of code or data. In some embodiments, a non-transitory storage medium is any available medium that is accessible by a computer. Also, in some embodiments, connecting components are properly termed computer-readable media. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” can be based on both condition A and condition B. In other words, the phrase “based on” shall be construed to mean “based at least in part on.” Also, the words “a” or “an” indicate “at least one.”

1. A method for data processing, comprising:
obtaining a user query, a first context example, and a second context example, wherein a combination of the first context example and the second context example exceeds a context window size of a language generation model;
generating, using a sub-batching component, a first input and a second input by appending the user query to the first context example and the second context example, respectively; and
generating, using the language generation model, a response to the user query based on the first input and the second input by processing the first input and the second input in parallel using an attention mechanism of the language generation model.

2. The method of claim 1, wherein:
each of the first context example and the second context example comprises a query-response pair.

3. The method of claim 1, wherein:
the user query comprises text corresponding to a domain of the first context example and the second context example.

4. (canceled)

5. The method of claim 1, wherein generating the response to the user query comprises:
generating an initial embedding of the first input and an initial embedding of the second input;
generating a subsequent embedding of the first input based on the initial embedding of the first input and the initial embedding of the second input; and
generating a subsequent embedding of the second input based on the initial embedding of the first input and the initial embedding of the second input.

6. The method of claim 5, further comprising:
generating a first normalization value based on the initial embedding of the first input;
generating a second normalization value based on the initial embedding of the second input; and
determining a combined normalization value based on the first normalization value and the second normalization value, wherein the subsequent embedding of the first input and the subsequent embedding of the second input are generated based on the combined normalization value.

7. The method of claim 6, further comprising:
computing a first set of attention components based on the initial embedding of the first input, wherein the first normalization value is based on the first set of attention components.

8. The method of claim 6, further comprising:
computing a second set of attention components based on the initial embedding of the second input, wherein the second normalization value is based on the second set of attention components.

9. The method of claim 6, wherein:
the combined normalization value comprises a softmax denominator.

10. The method of claim 1, wherein generating the response comprises:
performing mesa-optimization based on the first input and the second input.

11. A non-transitory computer readable medium storing code for data processing, the code comprising instructions that, when executed by at least one processor, cause the at least one processor to perform operations comprising:
obtaining a user query, a first context example, and a second context example, wherein a combination of the first context example and the second context example exceeds a context window size of a language generation model;
generating, using a sub-batching component, a first input and a second input by appending the user query to the first context example and the second context example, respectively; and
generating, using the language generation model, a response to the user query based on the first input and the second input by processing the first input and the second input in parallel using an attention mechanism of the language generation model.

12. (canceled)

13. The non-transitory computer readable medium of claim 11, wherein generating the response to the user query comprises:
generating an initial embedding of the first input and an initial embedding of the second input;
generating a subsequent embedding of the first input based on the initial embedding of the first input and the initial embedding of the second input; and
generating a subsequent embedding of the second input based on the initial embedding of the first input and the initial embedding of the second input.

14. The non-transitory computer readable medium of claim 13, the code further comprising instructions that, when executed by the at least one processor, cause the at least one processor to perform operations comprising:
generating a first normalization value based on the initial embedding of the first input;
generating a second normalization value based on the initial embedding of the second input; and
determining a combined normalization value based on the first normalization value and the second normalization value, wherein the subsequent embedding of the first input and the subsequent embedding of the second input are generated based on the combined normalization value.

15. The non-transitory computer readable medium of claim 14, the code further comprising instructions that, when executed by the at least one processor, cause the at least one processor to perform operations comprising:
computing a first set of attention components based on the initial embedding of the first input, wherein the first normalization value is based on the first set of attention components.

16. The non-transitory computer readable medium of claim 14, the code further comprising instructions that, when executed by the at least one processor, cause the at least one processor to perform operations comprising:
computing a second set of attention components based on the initial embedding of the second input, wherein the second normalization value is based on the second set of attention components.

17. The non-transitory computer readable medium of claim 11, wherein generating the response comprises:
performing mesa-optimization based on the first input and the second input.

18. A system comprising:
a memory component; and
a processing device coupled to the memory component, the processing device configured to perform operations comprising:
obtaining a user query, a first context example, and a second context example, wherein a combination of the first context example and the second context example exceeds a context window size of a language generation model;
generating, using a sub-batching component, a first input and a second input by appending the user query to the first context example and the second context example, respectively; and
generating, using the language generation model, a response to the user query based on the first input and the second input by processing the first input and the second input in parallel using an attention mechanism of the language generation model.

19. (canceled)

20. The system of claim 18, wherein generating the response to the user query comprises:
performing mesa-optimization based on the first input and the second input.
